(19) United States
(12) Patent Application Publication
(10) Pub. No.: US 2024/0051214 A1
(43) Pub. Date: Feb. 15, 2024

(54) PLASTIC BLANK HEATING METHOD AND APPARATUS

(71) Applicant: HUSKY INJECTION MOLDING SYSTEMS LTD., BOLTON (CA)

(72) Inventors: Sebastian RASCHE, Trier (DE); Joachim Johannes NIEWELS, Thorton (CA); Joaquim Martins NOGUEIRA, Everett (CA); Adam Christoph ULEMEK, Mississauga (CA)

(21) Appl. No.: 18/278,130

(22) PCT Filed: Feb. 10, 2022
(86) PCT No.: PCT/CA2022/050195

§ 371 Date: Aug. 21, 2023

Related U.S. Application Data
(60) Provisional application No. 63/155,952, filed on Mar. 3, 2021.

(51) Int. Cl. B29C 49/64; B29C 49/78; B29C 35/08

(52) U.S. Cl. CPC B29C 49/6418; B29C 49/6445; B29C 49/786; B29C 35/0805; B29C 2049/7862; B29C 2949/0715; B29C 2035/0855; B29L 2031/7158

(57) ABSTRACT

A method of heating plastic blanks for molding comprises, for each blank in a sequence of blanks of different types, determining a heating requirement corresponding to characteristics of the blank a molding process to be applied and heating each blank according to its heating requirement. A microwave field is generated having a defined heating rate, and the blank is placed in the microwave field for a period of time equal to the heating duration, such that the heating duration and the heating rate correspond to the heating requirement.

### FIELD

This relates to plastic molding, and more particularly, to heating of blanks for molding operations.

### BACKGROUND

Many plastic articles are produced using processes with multiple molding steps. For example, many containers, such as beverage containers, are produced in two shaping stages. In an initial shaping stage, molten molding material is shaped by injection molding into blanks, often referred to as preforms. In a second shaping stage, preforms are re-shaped by blow molding into final container shapes.

Blow molding processes are generally designed to occur at specific elevated temperatures, based on material characteristics, stretch ratios, desired finish characteristics and other parameters.

Typical systems are designed for large-scale processing of large quantities of identical blanks, into identical containers. Unfortunately, such systems provide little flexibility.

### SUMMARY

An example method of heating blanks for plastic molding comprises: a) receiving plurality of blanks in a sequence, the plurality of blanks comprising blanks of different types, each type for being molded in an associated molding process; b) for each blank in the sequence: i) determining a heating requirement corresponding to characteristics of the blank and the associated molding process; ii) generating a microwave field, the microwave field having a strength defining a heating rate; iii) determining a heating duration based on the heating requirement; iv) advancing the blank through the microwave field at a speed such that the blank is within the microwave field for a period of time equal to the heating duration, wherein the heating duration and the heating rate correspond to the heating requirement.

In some embodiments, the method comprises, for each blank in the sequence, measuring an input temperature of the blank prior to heating, and wherein the determining a heating requirement comprises adjusting a base heating requirement based on the input temperature.

In some embodiments, adjusting a base heating requirement based on the input temperature comprises comparing the input temperature to a nominal temperature.

In some embodiments, the input temperature comprises an axial temperature profile.

In some embodiments, the method comprises, for each blank in the sequence, adjusting the heating rate based on the input temperature.

In some embodiments, adjusting the heating rate comprises adjusting an output power of a microwave generator.

In some embodiments, adjusting the heating rate comprises positioning an attenuating device within the microwave field.

In some embodiments, the method comprises, for each blank in the sequence, selecting the speed based on the input temperature.

In some embodiments, the method comprises, for a blank in the sequence, holding the blank in a position so that a portion of the blank receives heat from the microwave field to heat the portion relative to the remainder of the blank.

In some embodiments, the method comprises, for a blank in the sequence, generating a circumferential temperature gradient around a circumference of the blank with the microwave field.

In some embodiments, generating a circumferential temperature gradient comprises moving a microwave-reflecting device to position a region of peak microwave intensity relative to the blank.

An example blank-heating apparatus for plastic molding comprises: a) a heating chamber; b) a microwave generator for emitting microwaves to the heating chamber by way of a wave guide; c) a blank conveying device for moving a blank along a heating axis into and out of the heating chamber; d) a controller operable to control a speed of the conveying device to define a heating duration based on a heating requirement of a blank.

In some embodiments, the blank-heating apparatus comprises a microwave-attenuating device extendable into the waveguide to control a rate of microwave heating within the heating chamber.

In some embodiments, the blank-heating apparatus comprises a microwave-reflecting device movable relative to the chamber to control a location of peak microwave intensity within the chamber.

In some embodiments, the blank-heating apparatus comprises a temperature measurement device proximate the heating chamber for measuring a temperature of a blank before entering the heating chamber.

In some embodiments, the temperature measurement device comprises a plurality of pyrometers.

In some embodiments, the controller is operable to control heating of a blank based on the input temperature of the blank.

In some embodiments, the controller is operable to control heating of a blank by setting a speed of the conveying device.

In some embodiments, the controller is operable to control heating of a blank by adjusting an output power of the microwave generator.

In some embodiments, the controller is operable to control heating of a blank by adjusting a position of the microwave-attenuating device.

Embodiments may comprise any combination of the above features.

### BRIEF DESCRIPTION OF DRAWINGS

In the figures, which depict example embodiments:

FIG. 1 is a schematic diagram of a molding system;

FIG. 2 is a top plan view of the molding system of FIG. 1;

FIG. 3 is an isometric view of a conditioning station of the system of FIG. 1;

FIG. 4 is an enlarged cross-sectional view of a heating chamber and waveguide of the conditioning station of FIG. 3;

FIG. 5 is a schematic diagram showing the heating chamber and waveguide of FIG. 4, with a standing microwave pattern;

FIGS. 6A-6B are side and top schematic views, respectively, of the heating chamber of FIG. 5, showing temperature measurement devices;

FIG. 7 is a schematic view showing a blank and a final molded article into which the blank is shaped;

FIGS. 8A and 8B are representative infeed and outfeed temperature profiles, respectively, of a blank;

FIG. 9 is a block diagram showing components of a control device;

FIG. 10 is a block diagram showing a data store of the control device of FIG. 9;

FIG. 11 is a flow chart showing a blank heating process;

FIG. 12 is a flow chart showing details of an initial body heating stage of the process of FIG. 11;

FIG. 13 is a flow chart showing details of a shoulder heating stage of the process of FIG. 11;

FIG. 14 is a flow chart showing details of a temperature smoothing stage of the process of FIG. 11; and

FIGS. 15A-15D are graphs showing axial temperature profiles of a blank at various stages of the process of FIG. 11.

### DETAILED DESCRIPTION

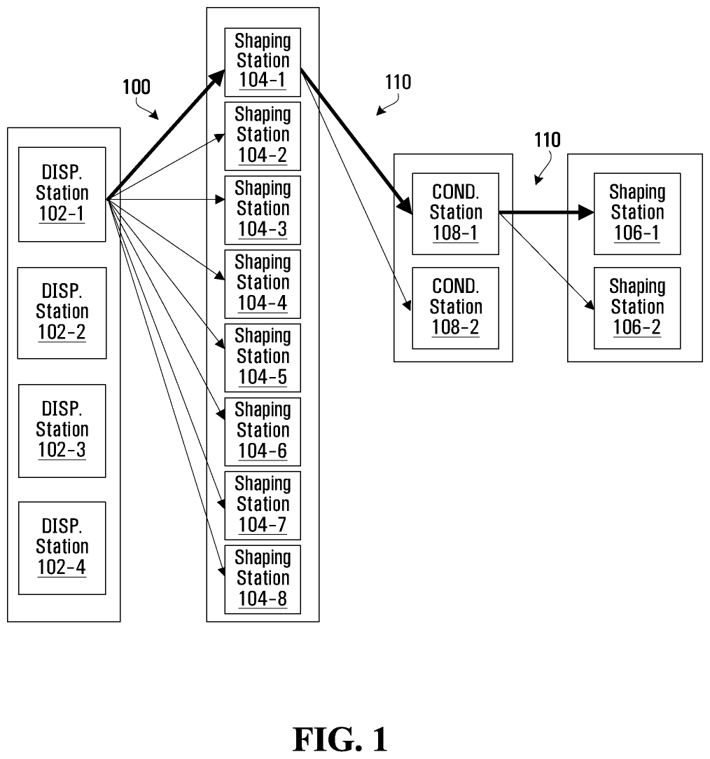

FIG. 1 schematically depicts an example plastic molding system 100 for producing plastic molded articles. As described in further detail below, plastic molding system 100 is capable of molding articles through a sequence of processing operations.

In particular, system 100 provides flexibility to produce articles of a variety of types. For example, system 100 can produce articles of varying shapes, sizes, colours and material composition.

Plastic molding system 100 includes a plurality of process stations. The stations include groups of stations that are each operable to perform the same type of processing operation. Specifically, the depicted embodiment comprises a plurality of dispensing stations 102, a plurality of shaping stations 104, a plurality of secondary shaping stations 106, and a plurality of conditioning stations 108.

Each of the dispensing stations 102 is operable to perform a dispensing operation, namely, producing an output of molding material for use in subsequent operations. Each of the shaping stations 104 is operable to perform a primary shaping operation. For example, each station 104 may include an injection mold for performing an injection molding operation. Each one of shaping stations 106 is operable to perform a secondary shaping operation. For example, each one of shaping stations 106 include a blow mold for re-shaping an injection molded article into a finished shape.

In an example, dispensing stations 102 comprise extruders for producing a flow of molten plastic molding material such as PET from a solid (e.g. pelletized) feedstock; shaping stations 104 are injection molding stations for producing blanks known as preforms to be subsequently re-shaped into containers such as beverage containers; and shaping stations 106 are blow molding stations for re-shaping the preforms.

Blow molding operations typically require blanks to be at a relatively high temperature (e.g., well above room temperature) for re-forming. Accordingly, blanks may be processed at conditioning stations 108 to heat the blanks prior to shaping at stations 106.

In some embodiments, dispensing stations 102 are operable to dispense a range of possible molding materials. For example, the dispensing stations may output molding materials having different colours, compositions, or other properties. Dispensing stations 102 may be configured to output molding material in discrete quantities, which may be referred to as doses. Likewise, different shaping stations 104 and different shaping stations 106 may include molds of different sizes or shapes. Collectively, system 100 may be capable of concurrently producing molded articles of a number of different types, with each specific type of article corresponding to a combination of a type and quantity of molding material from a dispensing station 102, a shape and size of an injection molded article from a shaping station 104, and a shape and size of a finished article from a shaping station 106.

The optimal temperature for blow molding operations at stations 106 may vary based on numerous factors, such as the type of material, mass of material to be molded, amount of stretching of material and desired final shape, desired wall thickness, and the preform shape and design. Moreover, the amount of heat and distribution of heat required to bring a preform to a desired thermal condition depends on factors such as material type, blank size, and distribution of mass within the blank.

In the depicted embodiment, conditioning stations 108 are controllable based on parameters associated with individual input blanks, to produce output blanks with specific desired thermal conditions.

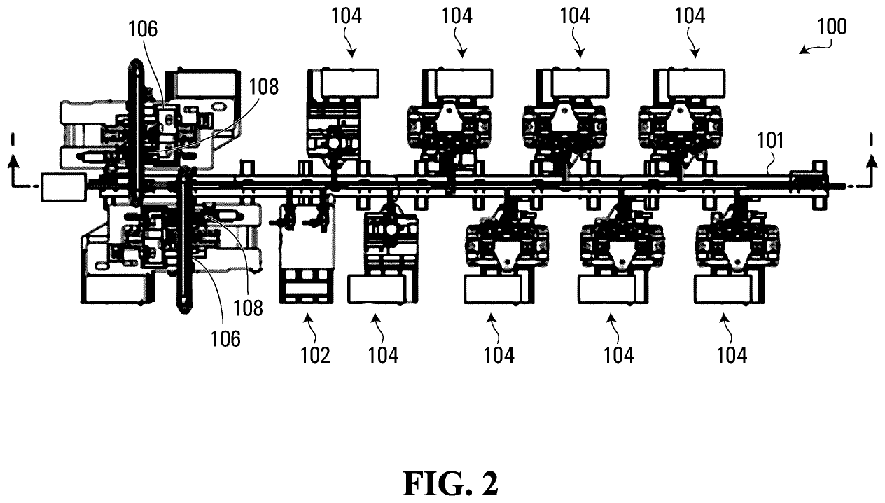

FIG. 2 depicts a top plan view of molding system 100. Stations of system 100 are positioned adjacent a transportation system, namely, a central track 101. In-progress and completed articles can be moved between stations along track 101. Each article produced using system 100 is processed at a combination of a specific dispensing station 102, a specific shaping station 104, a specific shaping station 106 and a specific conditioning station 108. Each unique combination may correspond to a unique type of molded article, and types may differ from one another in shape, size, colour, and material type, among other characteristics.

To accommodate such variety, conditioning stations 108 are capable of applying customized heat treatments to different blanks, tuned based on material and process characteristics, and actual conditions of the blanks.

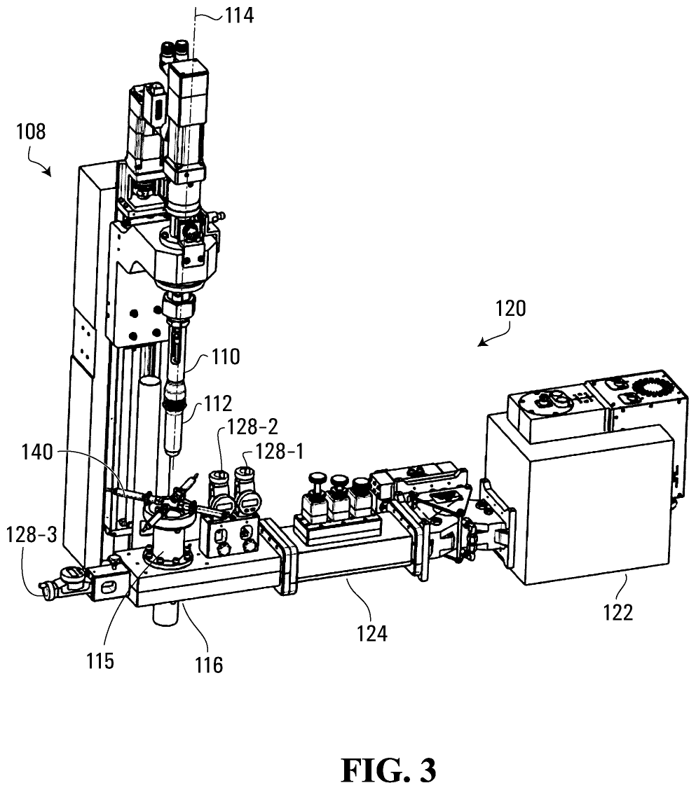

FIG. 3 depicts an example conditioning station 108. Conditioning station 108 includes a mandrel 110 operable to grip a blank 112. Mandrel 110 is coupled to a drive unit 118, operable to move mandrel 110 along a heating axis 114 and to rotate the mandrel 110 about the heating axis 114. The heating axis 114 passes through an infeed tube 115, which leads to a heating chamber 116.

Mandrel 110 functions as a conveying device for moving a blank 112 through into and out of the heating chamber. Specifically, using mandrel 110, a blank 112 can be advanced into heating chamber 116 along heating axis 114, and can be retracted from heating chamber 116 along heating axis 114. Mandrel can also rotate a blank 112 at a desired rate or to a desired angular orientation within chamber 116. In the depicted embodiment, mandrel 110 can move a blank 112 along heating axis 114 at a rate of up to 300 mm/s and can rotate a blank 112 about heating axis at a rate of up to 300 rpm.

Conditioning station 108 further includes a heating apparatus 120. Heating apparatus 120 is operable to apply heat to a blank 112 within heating chamber 116. Heat may be applied at a variable rate. Moreover, heat may be focally applied within heating chamber 116, such that one or more locations within heating chamber 116 experiences greater heating intensity than other locations.

In the depicted embodiment, heating apparatus 120 is a microwave heating apparatus. That is, heating apparatus is operable to apply heat to a blank 112 within heating chamber 116 by creating a microwave field within the chamber.

Heating apparatus 120 includes a microwave generator unit 122, a waveguide 124, a heating chamber 116 and a plurality of tuning pins 128-1, 128-2, 128-3 (individually and collectively, tuning pins 128). In the depicted embodiment, waveguide 124 includes a manual 3-stub tuner. However, the tuner may be omitted.

Microwave generator unit 122 comprises one or more magnetron heads operable to produce microwave emissions. In the depicted embodiment, the magnetron generators are capable of producing microwaves at a frequency of 2450 MHz and power of 3 kW.

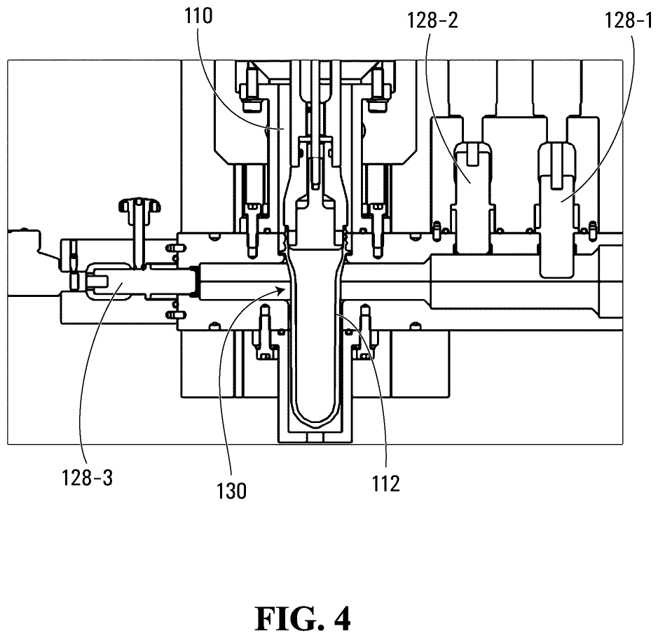

Microwave generator unit 122 is interconnected with heating chamber 116 by way of waveguide 124. FIG. 4 is a cross-sectional view showing the interior of waveguide 124 and heating chamber 116.

Waveguide 124 defines an internal passage and heating chamber 116 defines an internal cavity 130. Microwave radiation from microwave generator unit 122 passes into the internal passage 128 of waveguide 124 and the internal cavity 130 of heating chamber 116, and forms a standing wave pattern 132. The standing wave pattern is defined in part by the dimensions and shape of waveguide 124, and of internal cavity 130 of heating chamber 116, and by the material, temperature and design of blanks within the heating chamber.

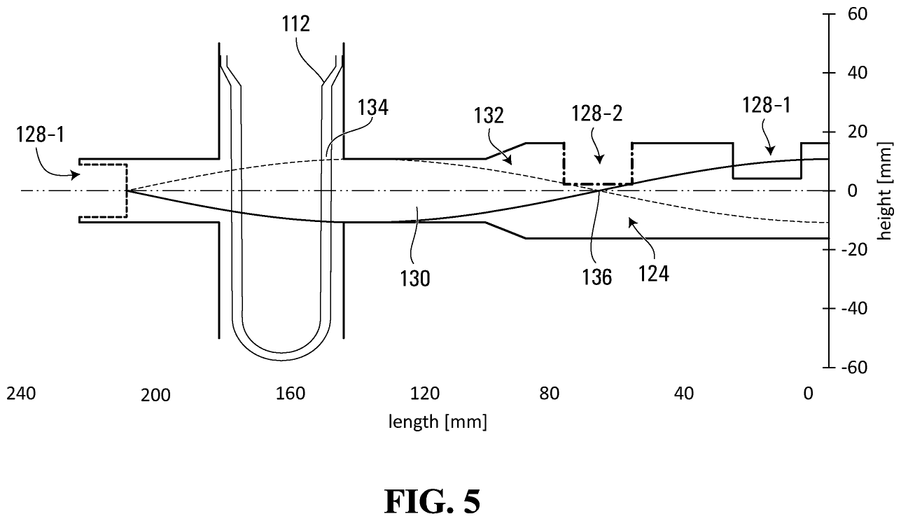

An example standing wave pattern is depicted in FIG. 5. As shown, the standing wave pattern 132 creates regions of high and low microwave intensity within internal cavity 130. High intensity regions 134 generally correspond to areas of constructive interference between microwaves. Low intensity regions 136 generally correspond to areas of destructive interference between microwaves.

As depicted in FIG. 5, high intensity region 134 is positioned proximate one side of the wall of blank 112. The portion of blank 112 within high-intensity region 134 experiences a high rate of microwave heat input. Conversely, the opposite side of blank 112 is in a region of comparatively lower microwave intensity and experiences a relatively lower rate of microwave heat input.

Accordingly, variation of microwave intensity at different positions within internal cavity 130 can produce differential rates of heating of different portions of blank 112. That is, parts of blank 112 in high-intensity regions tend to be heated more quickly than parts of blank 112 in lower-intensity regions. Thus, such variation may be used to create temperature gradients in blank 112. For example, the configuration shown in FIG. 5 would tend to produce a decreasing temperature gradient around the circumference of blank 112, from the part of blank 112 in high-intensity region 134 to the opposite part of blank 112 in a lower-intensity region.

In some cases, such a circumferential temperature gradient may be desirable. However, in other cases, it may be desired to produce a uniform temperature around the circumference of blank 112. In such cases, blank 112 may be rotated about its longitudinal axis using mandrel 110 so that average heat input is approximately even around the circumference of blank 112.

As is also shown in FIG. 5, only a small longitudinal portion of blank 112 lies within internal cavity 130 of heating chamber 116. Thus, only a small longitudinal portion of blank 112 is subjected to microwave heating. Accordingly, mandrel 110 may be used to advance blank 112 through internal cavity 130, along the longitudinal axis of the blank, so that heat may be applied along the entire longitudinal extent of blank 112, or the standing wave pattern may be tuned to locate high-intensity region 134 centrally within cavity 130, or to produce multiple high-intensity regions 134 spread evenly throughout cavity 130.

The amount of heat applied to blank 112 is governed by the intensity of microwave radiation to which the blank is exposed and the rate at which the blank is moved through heating chamber 116. If blank 112 is advanced slowly through heating chamber 116, the duration of time over which it is exposed to microwave heating is relatively large. Conversely, if it is advanced quickly through heating chamber 116, the duration of time over which it is exposed to microwave heating is relatively smaller, corresponding to relatively less total heat input.

In some cases, blank 112 may be advanced through heating chamber 116 at a constant rate, to apply a consistent amount of heat along the length of the blank. In other cases, it may be desirable to produce a temperature gradient along the length of blank 112. Such a gradient may be created by varying microwave intensity as blank 112 is advanced through heating chamber 116, such that different portions of blank 112 are exposed to microwave heating of different intensity. Additionally or alternatively, the rate at which blank 112 is advanced through chamber 116 may be varied. For example, in order to produce a relatively higher temperature in a first region, as compared to a second region, the rate of advance may be decreased while the first region is in chamber 116.

The output power of microwave generator unit 122 may be increased or decreased to increase or decrease the average microwave intensity within heating chamber 116.

Additionally or alternatively, microwave heating characteristics within heating chamber 116 may be controlled by movement of tuning pins 128.

Tuning pins 128 are formed of a material that attenuates microwaves. For example, tuning pins 128 may be formed of nonferrous metal such as CuZn₃₉Pb₃.

Average microwave intensity within heating chamber 116 can be reduced using tuning pins 128-1, 128-2. Specifically, tuning pins 128-1, 128-2 can be advanced into waveguide 124 to partially attenuate microwaves emitted by microwave generator unit 122, such that the mono mode microwave field strength within the heating chamber 116 is reduced. The amount of attenuation depends on how far tuning pins 128-1, 128-2 are advanced into waveguide 124. In an example, each tuning pin 128 may be extended or retracted through a stroke 14 mm in length. However, the length of the tuning pin stroke may depend on resonator designs. Tuning by movement of pins 128 allows for impedance matching of the blank in heating chamber 116. That is, the characteristics of the microwave field in heating chamber 116, as tuned using pins 128, and the blank in the chamber, produce an impedance between 0 and 1, reflecting the proportion of microwave energy transferred to the blank. By movement of pins 128, impedance may be moved closer to a theoretical maximum value of 1.

Tuning pin 128-3 reflects incident microwaves. Accordingly, during operation of microwave generator unit 122, the standing wave pattern within heating chamber 116 can be controlled by movement of tuning pin 128-3. Retraction of tuning pin 128-3 away from microwave generator unit 122 generally moves regions of high intensity in a direction away from microwave generator unit 122. Extension of tuning pin 128-3 generally moves regions of high intensity towards microwave generator unit 122 Thus, tuning pin 128-3 can be used to position high-intensity regions over only a portion of blank 112, such that different parts of the blank are heated at different rates, or to position high-intensity regions at a location, e.g. the center of heating chamber 116, such that blank 112 is heated evenly. In an example, pin 128-3 is formed of the same material as pins 128-1, 128-2.

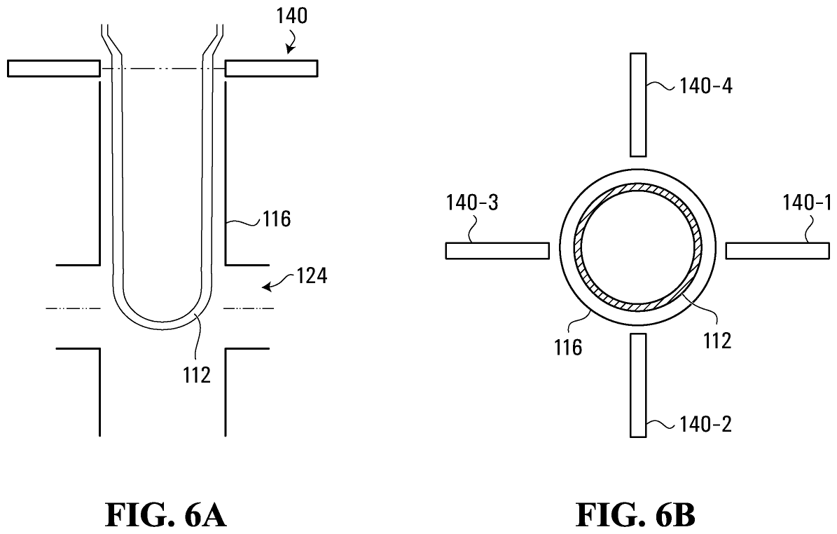

The amount of heating required to bring blank 112 to a desired thermal condition depends on the thermal condition of the blank prior to heating. Temperature sensors may be provided to measure the thermal condition of a blank 112 prior to heating. FIGS. 6A and 6B are side and top schematic views, respectively, showing configuration of temperature sensors.

In the depicted embodiment, the temperature sensors comprise pyrometers 140 positioned around heating axis 114 proximate an entry to heating chamber 116. As depicted, four pyrometers 140-1, 140-2, 140-3, 140-4 are present. However, in other embodiments, more or fewer pyrometers may be used. In some examples, suitable pyrometers may have high accuracy (e.g. error less than 1 degree celsius). Pyrometers may also be selected for fast response time, e.g. 9 ms or less. An example of a suitable pyrometer is model CTF-SF25-C3 produced by Micro Epsilon.

As blank 112 is advanced past pyrometers 140, the pyrometers obtain temperature measurements. Such measurements may be made continuously or at discrete time intervals.

Each measurement corresponds to a particular location along the axis of blank 112. Thus, a set of measurements from a particular pyrometer 140 describes a longitudinal temperature profile of the blank 112.

Each measurement likewise corresponds to a particular location on the surface of blank 112. That is, in the depicted case of a blank with generally cylindrical cross-section, each pyrometer obtains measurements at a particular circumferential location.

Measurements from a single pyrometer 140 may be considered as representative of the entire blank 112. Alternatively, multiple pyrometers may be used to acquire measurements at each location of interest on the surface of blank 112.

In the depicted embodiment, four pyrometers are positioned at equally-spaced intervals around the blank's circumference. That is, pyrometers 140-1, 140-2, 140-3, 140-4 are positioned approximately 90 degrees apart from one another.

The number and positioning of pyrometers 140 may be varied according to characteristics of blanks 112 or the processing thereof. For example, if blanks 112 have non-uniform or asymmetrical cross sections, temperatures at certain specific locations may be of particular interest.

Based on temperatures measured by each of multiple pyrometers 140, a circumferential temperature profile may be obtained. That is, sections around the circumference of blank 112 that are relatively hot or relatively cold may be identified.

A circumferential temperature profile may alternatively be obtained by rotating blank 112 about its longitudinal axis. Through such rotation, a circumferential temperature profile may be obtained using a single pyrometer.

The longitudinal temperature profile and circumferential temperature profile may be used in combination to determine heating requirements throughout blank 112.

Heating requirements may also be influenced by material properties of blank 112. For example, the material type, additives, colour, heat capacity and density of blank 112 may impact the amount of heating that is required to effect a given temperature increase.

Conditioning stations 108 may sequentially process blanks 112 of a variety of different types. For example, molding system 100 may concurrently fabricate objects such as liquid containers of multiple sizes, shapes and colours. Each blank 112 for a particular container type may have an associated thermal profile for optimal processing at a shaping station 106. The associated thermal profile may depend, for example, on material type, wall thickness of the specific type of blank 112 and of the container into which blank 112 is to be formed, and the material stretch ratios (hoop stretch ratio, axial stretch ratio and planar stretch ratio) that are necessary to achieve the final shape into which the blank 112 is to be formed.

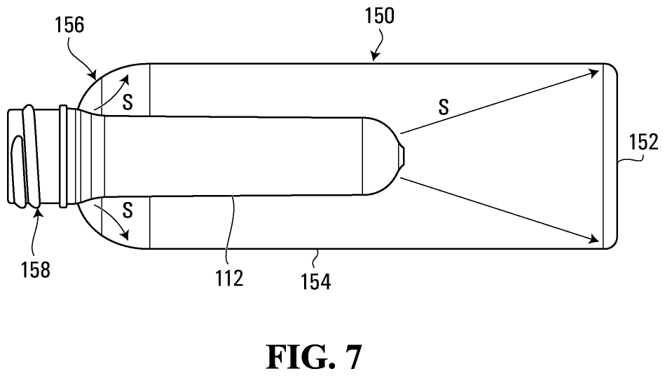

FIG. 7 depicts a representative blank 112 and a finished article, namely a container 150 into which the blank is to be shaped at a shaping station 106. Container 150 generally has a base section 152, a body section 154, a shoulder section 156 and a neck section 158. The neck section 158 may define threads or other retaining features rings for attachment of a closure. In order to be reshaped into container 150, the walls of blank 112 are stretched as indicated by arrows S. The stretching can be characterized in terms of hoop stretch, i.e. stretching in a radial direction; axial stretch, i.e. stretching in an axial direction, and planar stretch, i.e. a combination of hoop and axial stretch. As will be apparent, the amount of stretching varies across blank 112. For example, portions of the blank that are stretched to form body section 154 experience approximately uniform stretching. Conversely, stretching in shoulder section 156 and base section 152 are non-uniform.

In addition, some portions of blank 112 are stretched very little or not at all during shaping at shaping station 106. For example, the neck section 158 may not be re-shaped.

Precise temperature control plays an important role in ensuring quality and consistency of finished articles.

Uniform temperature distribution generally promotes consistency in the finished molded article, e.g. consistent surface appearance and wall thickness. However, higher temperatures may be required at areas that experience large stretch ratios. Conversely, lower temperatures may be desired at areas that are stretched very little or are not stretched at all, such as the threaded closure section of the neck. Maintaining low temperatures in such areas limits the possibility of undesired deformation or creep. For shaping long, round articles such as bottles, uniform circumferential temperature distribution may be of particular importance. However, significant temperature variation may be desired in the longitudinal direction to accommodate differing stretch ratios at different locations on the bottle.

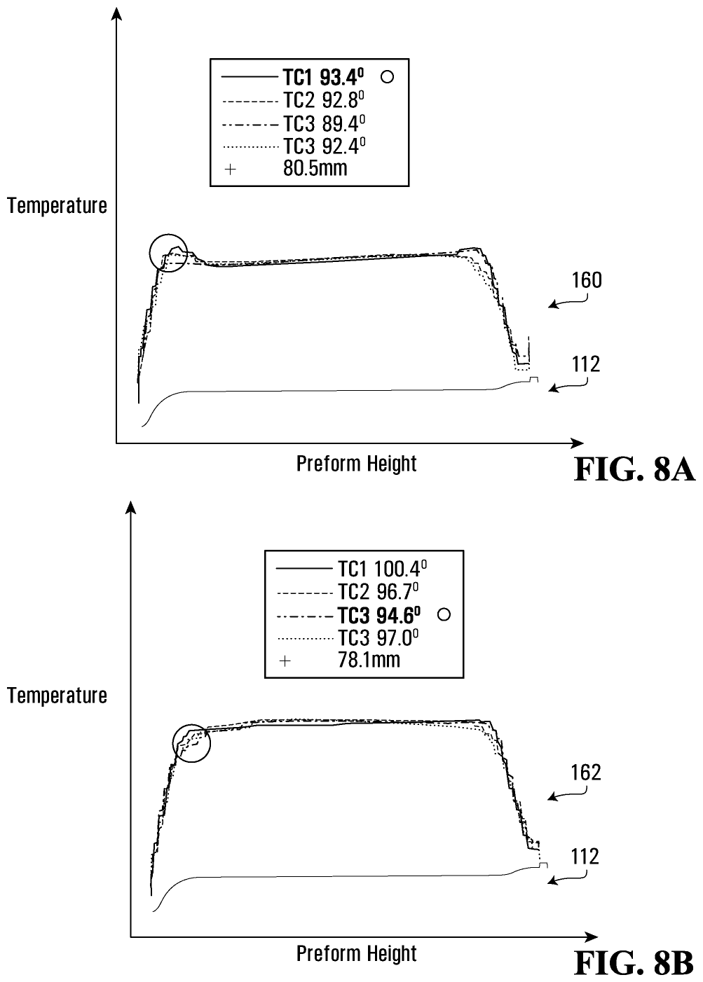

FIGS. 8A-8B respectively depict example axial temperature profiles of a blank prior to and after heating at conditioning station 108.

The temperature profile prior to heating may be referred to as the infeed temperature profile. In the depicted example, a single infeed temperature profile is produced by averaging of readings from all pyrometers 140 around the circumference of blank 112. However, multiple infeed temperature profiles may be measured at different positions on the circumference of the blank.

The infeed temperature profile 160, shown in FIG. 8A, is influenced by, for example, the amount of heat generated during processing at dispensing station 102 and shaping station 104, and the amount of heat lost subsequent to such processing. The infeed temperature profile may be variable. For example, heat from dispensing station 102 and shaping station 104 may vary somewhat, and the amount of time elapsed (and thus, the amount of heat lost) between the stages of processing a blank 112 may also vary. Some variables are based on differences between processing of different blank types. For example, certain types of material may be dispensed at higher temperatures than other types of material. Other variables are based on cycle-to-cycle variation among blanks of a given type. For example, the amount of time elapsed between processing steps may be different for each individual blank 112.

As is apparent from FIG. 8A, the infeed axial temperature profile may not be constant. That is, temperature gradients may exist along the axis of blank 112. In the depicted example, temperature peaks exist proximate the base section 152 and shoulder section 156 of blank 112, and temperature generally decreases in an axial direction from shoulder section 156 to base section 152. The precise location of any peaks, and the amounts of gradients may vary from blank to blank.

As is shown in FIG. 8B, the outfeed axial temperature profile 162 is elevated relative to the infeed temperature profile 160, and is generally more uniform. In order to achieve a desired axial temperature profile from an uneven infeed axial temperature profile, heat is applied in a non-uniform manner along the length of blank 112.

Conditioning cell 108 may be operated by a control system configured to tune a heating treatment applied to each individual blank 112 in order to achieve a desired outfeed temperature profile, based on a variety of characteristics such as the size, material and additive properties of the blank, shape into which the blank is to be formed, and input thermal conditions of the blank.

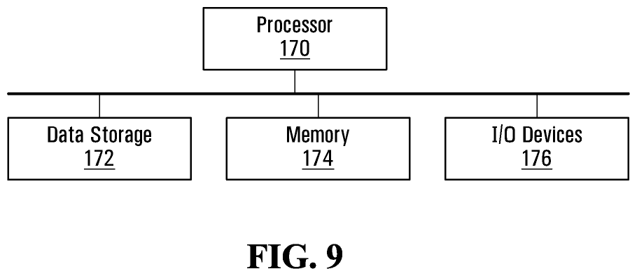

FIG. 9 depicts example control components for operating conditioning cell 108. The control components include a control processor 170, a data store 172, working memory 174, and a plurality of input/output devices 176.

In the depicted embodiment, the control components are implemented using a virtualized PLC running on an industrial computer. Suitable industrial computers are Beckhoff GmbH series C6930 PCs based on multi-core intel CPUs and Microsoft Windows 10 operating system. Virtualized PLCs may be implemented in the Beckhoff TwinCAT 3 PLC runtime. Additionally or alternatively, controls may be implemented using a traditional (physical) PLC.

Input/output devices 176 include interfaces to a plurality of sensors and actuators. The sensors include pyrometers 140 and one or more position sensors for determining the position of a blank 112. The position sensors may directly measure the position of blank 112 or may infer the position based on measuring the position of mandrel 110.

The actuators include linear actuators for positioning tuning pins 128, devices for controlling the rates of axial movement and rotation of mandrel 110, and for controlling the output power of microwave generator unit 122.

The conditioning cell may communicate with one or more other controllers by way of network connection 177. For example, the conditioning cell may communicate with a supervisory controller responsible for coordinating overall operation of system 100. The supervisory controller may, for example, define a sequence of blanks to be processed at conditioning cell 108.

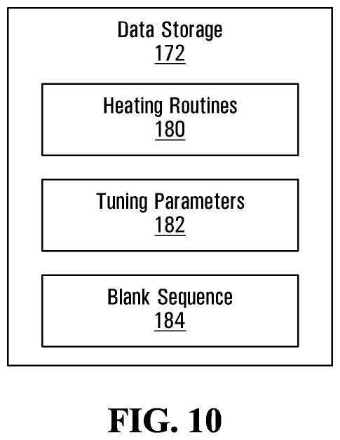

Referring to FIG. 10, data store 172 contains instructions for access by control processor 170 during operation. The instructions include base heating routine definitions 180 and tuning parameters 182.

Base heating profile definitions 180 provide a desired thermal condition for blanks of each type of article produced at molding system 100 (referred to as SKUs). That is, for each SKU, a heating profile definition 180 is provided, defining a thermal condition for blanks 112 to be processed at shaping stations 106.

For some SKUs, base heating profile definitions 180 may define circumferential heat profiles, as well as axial profiles. For example, SKUs that are molded into shapes having oval or other non-circular cross-sections may require concentrations of heat at the areas that experience the greatest amount of stretching.

In an example embodiment, heating profile definitions are characterized in terms of operations to be performed to blanks. For example, a heating profile definition may define a baseline microwave output power, tuning pin positions, and linear feed rate of the blank 112 through heating chamber 116. For SKUs that require non-uniform circumferential heat distribution, the heating profile definitions may prescribe specific synchronization of the positions of tuning pins 128-1, 128-2 with rotation of blank 112. Alternatively, such heating profile definitions may prescribe positioning of tuning pin 128-3 in order to position the peak microwave intensity as desired.

Alternatively, a heating profile definition may be characterized in terms of a desired output temperature profile, and corresponding output power, pin positions and feed rate may be derived from such temperature output profile.

Tuning parameters 182 comprise adjustments to be applied to base heating profiles 180 based on operational conditions.

Tuning parameters may comprise scalar adjustments corresponding to various blank characteristics. For example, a scalar factor may be applied to increase a base heating regime by a specific amount for blanks of each possible colour, or for transparent blanks. Such scalar adjustments may include proportional increase of microwave output power, or decrease of linear feed rate, to increase the amount of heat applied to a blank. Conversely, scalar adjustments may include proportional decrease of output power or increase of linear feed rate to increase the amount of heat applied to a blank.

Tuning parameters may also comprise functions for correcting heating based on the thermal profile of blanks 112 entering heating chamber 116. For example, a nominal thermal profile may be stored, representing an input thermal profile corresponding to the base heating profile 180. Actual measured thermal profiles may be compared to the nominal profile, and the actual heating profile may be increased or decreased to compensate for deviation from the nominal profile. In some embodiments, nominal profiles may be different for different SKUs.

Data store 172 may also contain a blank sequence definition 184. Blank sequence definition 184 reflects a sequence of blanks 112 to be processed at conditioning station 108—that is, a sequence of SKUs corresponding to the blanks.

Blanks 112 may be heated in a plurality of stages in order to produce a desired temperature profile.

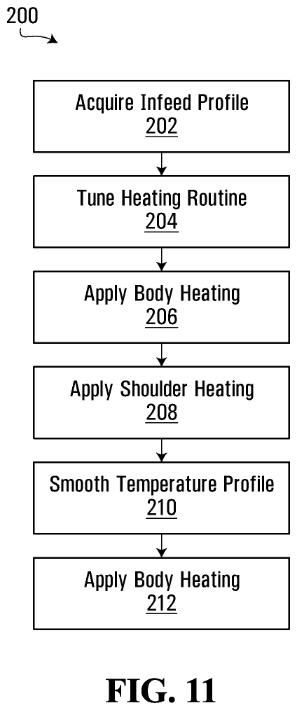

FIGS. 11-14 depict an example multi-stage heating process 200 for heating a blank 112 having a base section 152, a body section 154, a shoulder section 156 and a neck section 158.

At block 202, mandrel 110 moves blank 112 past pyrometers 140 and towards heating chamber 116. Using pyrometers 140, an infeed temperature profile for the blank is acquired.

At block 204, a base heating profile is selected based on the type of blank 112 and the shaping operation to be performed on the blank at shaping station 106. The base heating profile is tuned based on the infeed temperature profile. In an example, if the infeed temperature profile is higher than a nominal expected infeed temperature profile, the speed at which blank 112 is moved through heating chamber 116 is increased, so that the duration of heating is reduced. If the infeed temperature profile is lower than a nominal expected infeed temperature profile, the speed at which blank 112 is moved through heating chamber 116 is decreased so that the duration of heating is increased.

Additionally or alternatively, microwave output power may be increased or tuning pins 128-1, 128-2 may be withdrawn to reduce microwave attenuation if the infeed temperature profile is lower than a nominal expected profile, and microwave output power may be decreased or tuning pins 128-1, 128-2 may be extended to increase microwave attenuation if the infeed temperature profile is higher than a nominal expected profile.

For some SKUs, tuning pin 128 may be moved relative to the heating chamber to position the peak microwave intensity at a desired location, so that certain circumferential portions of the blank 112 are preferentially heated.

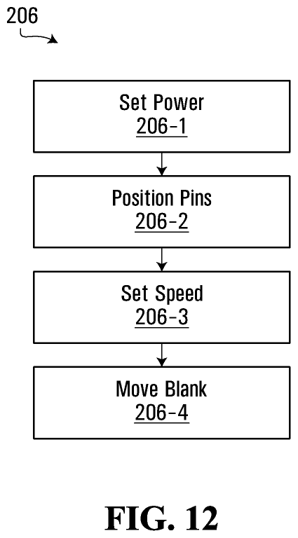

At block 206, an initial heating stage is applied to the entirety of blank 112. Details of the initial heating stage are shown in FIG. 12.

At block 206-1, microwave output power is set based on the tuned heating profile.

At block 206-2, tuning pins 128-1, 128-2, 128-3 are positioned according to the tuned heating profile. Specifically, pins 128-1, 128-2 are extended into waveguide 124 or retracted from waveguide 124 to attenuate microwaves as specified by the heating profile. Pin 128-3 is extended or retracted to locate regions of peak microwave intensity at the same position within heating chamber 116 as the wall of blank 112.

At block 206-3, the axial speed at which mandrel 110 moves blank 112 is set based on the tuned heating profile. The axial speed determines the duration over which blank 112 is within heating chamber 116 and exposed to heat. The amount of heat input varies inversely with the speed and is proportional to the product of the microwave output power, as attenuated by tuning pins 128-1, 128-2, and the duration of heating.

At block 206-4, blank 112 is advanced through heating chamber 116.

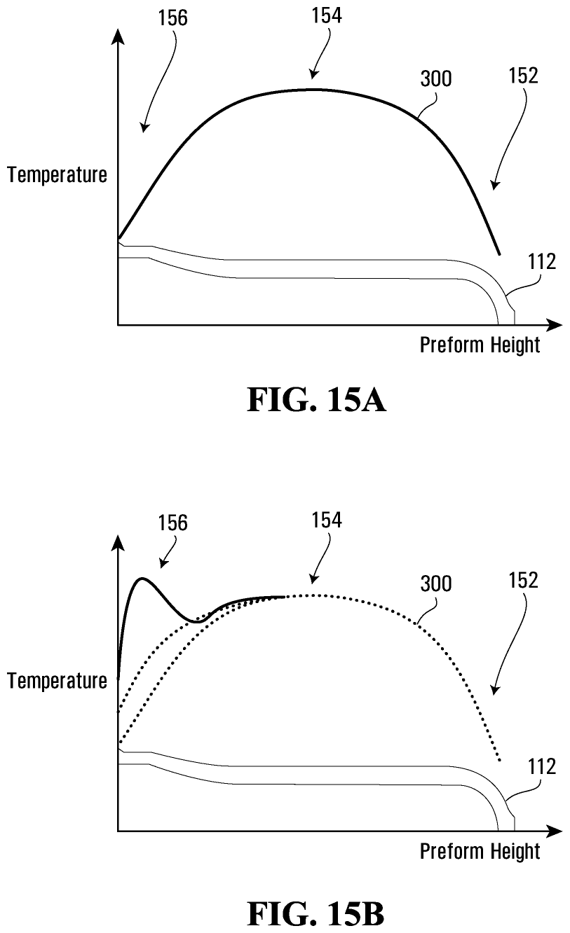

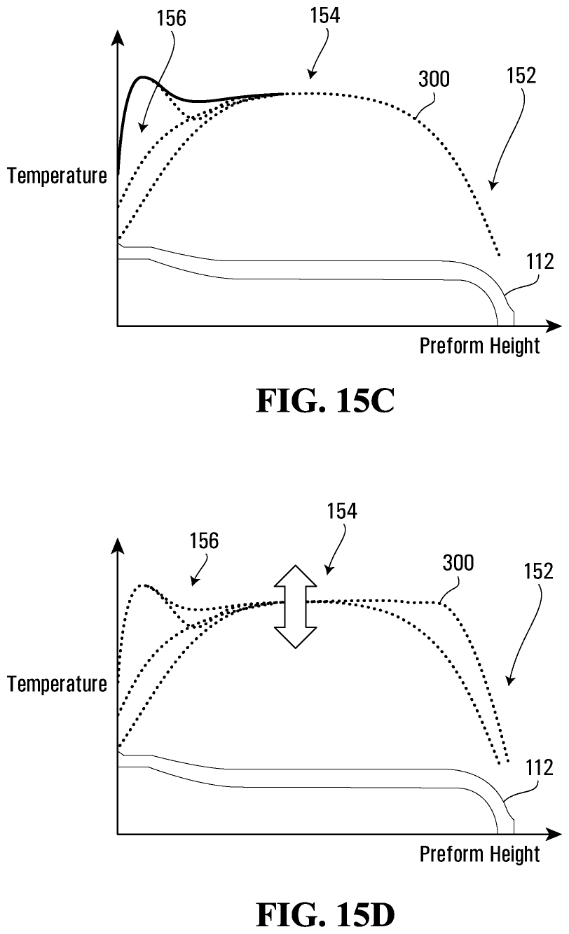

An example temperature profile 300 of blank 112 following initial heating is shown in FIG. 15A. The initial heating produces a generally even temperature profile through the body section 154 of blank 112. Temperatures in base section 152 and shoulder section 156 tend to be somewhat lower, because of the greater mass of material in the base section 152, shoulder section 156. In the depicted example, neck section 158 is not heated or is minimally heated, because neck section 158 has threads for a container closure and is not stretched during shaping at shaping station 106.

Typically, during shaping at shaping station 106, shoulder section 156 experiences a large amount of stretching, which requires relatively high temperatures.

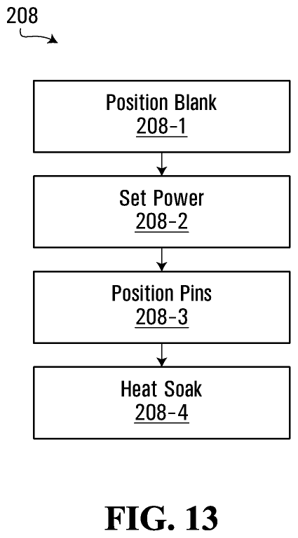

Referring to FIG. 11, at block 208, additional heat is applied to shoulder section 156. Details of shoulder heating are shown in FIG. 13.

At block 208-1, mandrel 110 moves the blank is moved to a shoulder-heating position. The shoulder-heating position is a position in which the shoulder region 156 is positioned within an area of peak microwave intensity. The shoulder-heating position is defined by the geometry of heating chamber 116 and the geometry of blank 112 and may be defined as part of the base heating profile.

At blocks 208-2 and 208-3, respectively, the microwave output power is set, and pins 128-1, 128-2 are positioned to attenuate microwaves according to the tuned heating profile.

At block 208-4, heat is applied to the shoulder region 156. Blank 112 is held stationary at the shoulder-heating position for a period defined in the tuned heating profile, which may be referred to as a heat soak period. During this period, heat is preferentially applied to the shoulder region 156 so that the temperature of the shoulder region 156 is raised relative to the remainder of the blank 112.

FIG. 15B depicts an example temperature profile 300 of blank 112 following shoulder heating. As depicted, shoulder heating tends to produce a local temperature peak at the shoulder region 156.

Sharp temperature variations such as the local temperature peak depicted in FIG. 15B generally are not desirable, as they can produce inconsistencies during subsequent shaping operations, such as varying wall thickness.

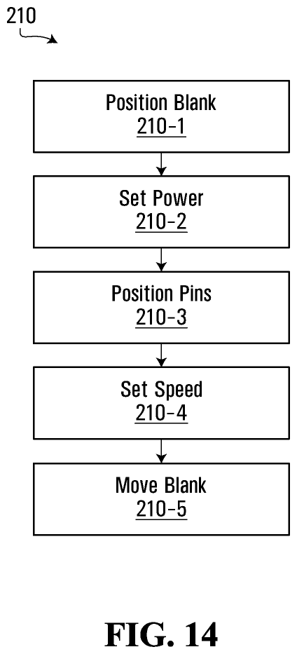

Referring again to FIG. 11, at block 210, the temperature profile in the vicinity of shoulder 156 is smoothed by application of additional heat. Details of this temperature smoothing are depicted in FIG. 14.

At block 210-1, mandrel 110 moves to position blank 112 at the shoulder-heating position.

At block 210-2, microwave output power is set based on the tuned heating profile.

At block 210-3, tuning pins 128-1, 128-2, 128-3 are positioned according to the tuned heating profile to provide the desired attenuation and locate regions of peak microwave intensity at the same position within heating chamber 116 as the wall of blank 112.

At block 210-4, the axial speed at which mandrel 110 moves blank 112 is set based on the tuned heating profile.

At block 210-5, blank 112 is advanced through heating chamber 116. Heat is applied only to a portion of blank 112 adjacent shoulder portion 156.

Referring again to FIG. 11, at block 212, an additional heating step is applied to the entirety of blank 112. The heating at block 212 follows steps generally identical to those of block 206 described above, except that the power and speed are set to incrementally heat the blank 112 to a desired temperature.

Following heating of a blank, mandrel 110 withdraws the blank from heating chamber 116 and transfers the blank to shaping station 106. The mandrel 110 may then pick up another blank and process 200 may be repeated for the subsequent blank.

Conveniently, unique heating treatments may be applied to each blank, based on the SKU of the blank and the associated material and physical characteristics, and the infeed temperature profile. Accordingly, conditioning cell 108 may provide precise thermal conditioning to prepare a variety of types of blanks for any of a variety of possible shaping operations. Such unique heating treatments may be applied to any arbitrary sequence of blank types. Conditioning cell 108 therefore enables system 108 to concurrently produce articles of a plurality of types, and in varying numerical proportion to one another.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

The term “comprise”, including any variation thereof, is intended to be open-ended and means “include, but not limited to,” unless otherwise specifically indicated to the contrary.

When a set of possibilities or list of items is given herein with an “or” before the last item, any one of the listed items or any suitable combination of two or more of the listed items may be selected and used.

The above described embodiments are intended to be illustrative only. Modifications are possible, such as modifications of form, arrangement of parts, details and order of operation. The examples detailed herein are not intended to be limiting of the invention. Rather, the invention is defined by the claims.

1. A method of heating blanks for plastic molding, comprising:
a) receiving plurality of blanks in a sequence, said plurality of blanks comprising blanks of different types, each type for being molded in an associated molding process;
b) for each blank in said sequence:
i) determining a heating requirement corresponding to characteristics of said blank and the associated molding process;
ii) generating a microwave field, said microwave field having a strength defining a heating rate;
iii) determining a heating duration based on said heating requirement;
iv) advancing said blank through said microwave field at a speed such that said blank is within said microwave field for a period of time equal to said heating duration,
wherein said heating duration and said heating rate correspond to said heating requirement.

2. The method of claim 1, comprising, for each blank in said sequence, measuring an input temperature of said blank prior to heating, and wherein said determining a heating requirement comprises adjusting a base heating requirement based on said input temperature.

3. The method of claim 2, wherein adjusting a base heating requirement based on said input temperature comprises comparing said input temperature to a nominal temperature.

4. The method of claim 2, wherein said input temperature comprises an axial temperature profile.

5. The method of claim 2, comprising, for each blank in said sequence, adjusting said heating rate based on said input temperature.

6. The method of claim 5, wherein adjusting said heating rate comprises adjusting an output power of a microwave generator.

7. The method of claim 5, wherein adjusting said heating rate comprises positioning an attenuating device within said microwave field.

8. The method of claim 2, comprising, for each blank in said sequence, selecting said speed based on said input temperature.

9. The method of claim 2, comprising, for a blank in said sequence, holding said blank in a position so that a portion of said blank receives heat from said microwave field to heat said portion relative to the remainder of said blank.

10. The method of claim 9, comprising, for a blank in said sequence, generating a circumferential temperature gradient around a circumference of said blank with said microwave field.

11. The method of claim 10, wherein generating a circumferential temperature gradient comprises moving a microwave-reflecting device to position a region of peak microwave intensity relative to said blank.

12. A blank-heating apparatus for plastic molding, comprising:
a) a heating chamber;
b) a microwave generator for emitting microwaves to said heating chamber by way of a wave guide;
c) a blank conveying device for moving a blank along a heating axis into and out of said heating chamber;
d) a controller operable to control a speed of said conveying device to define a heating duration based on a heating requirement of a blank.

13. The blank-heating apparatus of claim 12, comprising a microwave-attenuating device extendable into said waveguide to control a rate of microwave heating within said heating chamber.

14. The blank-heating apparatus of claim 13, comprising a microwave-reflecting movable relative to said chamber to control a location of peak microwave intensity within said chamber.

15. The blank-heating apparatus of claim 13, comprising a temperature measurement device proximate said heating chamber for measuring an input temperature of a blank before entering said heating chamber.

16. The blank-heating apparatus of claim 15, wherein said temperature measurement device comprises a plurality of pyrometers.

17. The blank-heating apparatus of claim 15, wherein said controller is operable to control heating of a blank, based on the input temperature of said blank.

18. The blank-heating apparatus of claim 17, wherein said controller is operable to control heating of a blank by setting a speed of said conveying device.

19. The blank-heating apparatus of claim 17, wherein said controller is operable to control heating of a blank by adjusting an output power of said microwave generator.

20. The blank-heating apparatus of claim 17, wherein said controller is operable to control heating of a blank by adjusting a position of said microwave-attenuating device.
